(19) United States
(12) Patent Application Publication
(10) Pub. No.: US 2024/0148611 A1
(43) Pub. Date: May 9, 2024

(54) CONTAINER AND SYSTEM FOR RECONSTITUTION AND ADMINISTRATION OF DRUGS

(71) Applicant: B. Braun Medical Inc., Bethlehem, PA (US)

(72) Inventors: Neil KORNEFF, Yorba Linda, CA (US); John NGUYEN, Garden Grove, CA (US); Nick Panick, Irvine, CA (US); Sandro Salonga, Tustin, CA (US); Robert Turner, San Clemente, CA (US); Kevin Duke Mai, Anaheim Hills, CA (US); Peter Anthony Klaes, Mission Viejo, CA (US)

(73) Assignee: B. Braun Medical Inc., Bethlehem, PA (US)

(21) Appl. No.: 17/979,907

(22) Filed: Nov. 3, 2022

(51) Int. Cl. A61J 1/20; A61J 1/10; A61J 1/14

(52) U.S. Cl. CPC A61J 1/2089; A61J 1/10; A61J 1/1406; A61J 1/201; A61J 1/2055

(57) ABSTRACT

A pharmaceutical vial, container assembly, system and method. The vial can include a hollow body, a first passage, a second passage, a first temporary closure sealing the first passage, and a second temporary closure sealing the second passage. A diluent container can include a first connector to connect the diluent container and vial in fluid communication for mixing an active pharmaceutical ingredient with a diluent. An infusion set can include a second connector to connect the infusion set and vial in fluid communication, and a delivery device. The method can include the steps of connecting the diluent container to the first temporary closure of the vial, transferring a diluent from the diluent container into the vial, reconstituting an active pharmaceutical ingredient with the diluent to form a solution, connecting the delivery device to the second temporary closure, and administering the solution through the delivery device into a patient.

### FIELD

The present disclosure relates generally to the reconstitution of drugs, and more specifically to containers and systems that allow drugs, such as drugs in dry form, concentrated liquid form, or other form, to be efficiently packaged, stored, reconstituted and administered to patients.

### BACKGROUND

Active pharmaceutical ingredients (APIs) are often distributed in concentrated form, rather than pre-mixed with diluent into solutions. A major reason for this is that the solutions have a limited shelf-life. Some solutions are also sensitive to environmental conditions, such as temperature conditions during shipping and storage. Therefore, it is common to reconstitute APIs with diluent within a short time period prior to administration to the patient.

There are a number of options available for packaging and reconstituting APIs. One option uses a standard drug vial containing the API, a specially designed bag containing a diluent, and a connector for interconnecting the vial to the bag. The vial has one opening surrounded by a flange and sealed by a stopper. The bag has two ports: a filling/mixing port and an outlet port. The connector has a first end with a saddle designed to connect to the filling/mixing port, and a second end designed with a spike designed to penetrate through the stopper in the vial. Once the vial and bag are connected to one another with the connector, the connected vial and bag can be stored. The API can be reconstituted by agitating or shaking the vial and bag to transfer diluent through the connector into the vial. After mixing, the outlet port on the bag is connected to a spike on an intravenous (IV) set that is attached to patient. The bag is then hung or suspended above the patient to administer the solution through the IV set.

One drawback to this approach is that the connector adds a third part that must be manufactured. This third part must also be handled by healthcare personnel who must be trained on how to use the connector. Separate steps are required for connecting the connector to the bag and to the vial. Another drawback is that the bag must be manufactured with two separate ports, which adds production steps and creates two separate areas of ingress/egress that require sealing.

Another option features a specially designed container that contains the API and a specially designed bag that contains the diluent. The API container is manufactured with a unique geometry designed to connect directly to the bag. The bag has an inlet opening that connects to the API container, and an outlet opening on the opposite side of the bag. After the API container is connected to the inlet opening, the API and diluent can be mixed by agitating the bag. The bag has an internal plug that seals the outlet opening. To administer the solution, the user must manually squeeze the bag and manipulate the plug with their fingers by pressing through the wall of the bag.

The drawback to this approach is that both the API container and bag require special geometries and parts. The API container has a unique geometry that does not conform to industry standards for vials, and therefore cannot be filled using conventional filling machines. In addition, the plug introduces an additional part to the bag that must be manufactured. The bag requires more dexterity and skill to administer a solution as compared to conventional IV bags, due to the internal plug. In addition, the bag has two separate ports like the previous example, which adds production steps and creates two separate areas of ingress/egress that require sealing.

### SUMMARY

The present disclosure describes an improved API container and system that avoid many of the drawbacks of other options. The API container of the present disclosure can be filled with an API in dry form, concentrated liquid form, or other form, using standard filling equipment. In addition, the API container can connect directly to a bag containing a diluent to facilitate reconstitution. The improved bag has a vial spike, which can be a conventional or commercially available vial spike on the market that works with standard vials, and that connects directly to the API container. The API container can also connect directly to an infusion set without having to disconnect the API container from the bag. Therefore, the solution can be administered through the API container and infusion set to a patient. This avoids the need to provide a second outlet port on the bag to connect to the infusion set.

The API container of the present disclosure offers the advantages of a standard vial during the filling process because it can work with conventional filling machines. The API container of the present disclosure also has the added capability of administering a reconstituted drug to a patient through an infusion set. Therefore, the API container of the present disclosure will be referred to herein as a vial-set port or “VSP” because it functions in some ways as a standard vial and in other ways as an infusion set port.

A number of containers and systems are described in the present disclosure, each being considered as a separate embodiment, but with features that may be combined or interchanged with features of other embodiments.

In one aspect of the disclosure, a pharmaceutical vial for packaging, storing, reconstituting and administering an active pharmaceutical ingredient can include a hollow elongated body, a first end defining a first passage, a second end defining a second passage, a first temporary closure sealing the first passage, and a second temporary closure sealing the second passage. The hollow elongated body can include a first body section that includes the first end and a second body section that includes the second end. The first body section can have a first inner diameter and the second body section can have a second inner diameter less than or equal to the first inner diameter. The hollow elongated body can also include a third body section between the first body section and the second body section. The third body section can include or form a tapered funnel between the first passage and the second passage.

In another aspect, the first end can define a first opening and the second end can define a second opening.

In another aspect, the first temporary closure can be positioned in the first opening.

In another aspect, the second temporary closure can be positioned in the second passage and recessed from the second opening.

In another aspect, the second passage can form a receptacle configured to receive a spike on an infusion set.

In another aspect, the second temporary closure can include a breakable member configured to separate from an inner wall of the second passage when a spike on an infusion set is received in the second passage.

In another aspect, the first temporary closure can include an elastomeric material configured to be penetrated by a cannula or a spike.

In another aspect, the first temporary closure can include a stopper.

In another aspect, the first end can include a cap that is crimped over the stopper.

In another aspect, the first end can include a cover that is detachably connected to the first body section and over the cap.

In another aspect, the first end can include a first flange extending radially outwardly from the hollow elongated body.

In another aspect, the second passage and second temporary closure can be covered by a removable barrier applied over the second end.

In another aspect, the pharmaceutical vial includes an active pharmaceutical ingredient stored in the hollow elongated body.

In another aspect, the second end can be configured to form a dry break connection.

In another aspect, the second end can include a Luer connector.

In another aspect, the second end can include a stopper.

In another aspect, the second end can include a displacement valve.

In another aspect, the pharmaceutical vial can include one or more mechanisms for preventing or mitigating against oxygen, light and/or moisture penetration.

In another aspect, the one or more mechanisms for preventing or mitigating against oxygen, light and/or moisture penetration can include an overwrap, a pouch, a film, a barrier, a wrap, a sheath, an oxygen scavenger, and a desiccant.

In another aspect, a container assembly for reconstituting an active pharmaceutical ingredient with a diluent to form a solution, and for administering the solution to a patient, can include a pharmaceutical vial configured to package, store and reconstitute the active pharmaceutical ingredient, and configured to administer the solution to the patient. The vial can include a hollow elongated body, a first end defining a first passage, a second end defining a second passage, a first temporary closure sealing the first passage, and a second temporary closure sealing the second passage.

In another aspect, the container assembly can include a diluent container configured to package and store the diluent, and configured to administer the solution. The diluent container can include a connector configured to penetrate the first temporary closure of the pharmaceutical vial to connect the diluent container and the pharmaceutical vial in fluid communication for mixing the active pharmaceutical ingredient with the diluent. The hollow elongated body can also include a first body section that includes the first end and a second body section that includes the second end.

In another aspect, the first body section can include a first inner diameter and the second body section include a second inner diameter less than or equal to the first inner diameter.

In another aspect, the hollow elongated body can include a third body section between the first body section and the second body section.

In another aspect, the third body section can include or form a tapered funnel between the first passage and the second passage.

In another aspect, a system for administering a pharmaceutical solution can include a pharmaceutical vial configured to package, store and reconstitute an active pharmaceutical ingredient, and configured to administer the solution to the patient. The pharmaceutical vial can include a hollow elongated body, a first end defining a first passage, a second end defining a second passage, a first temporary closure sealing the first passage, and a second temporary closure sealing the second passage.

In another aspect, the system for administering a pharmaceutical solution can include a diluent container configured to package and store a diluent, and configured to administer the solution to the patient. The diluent container can include a first connector configured to penetrate the first temporary closure of the pharmaceutical vial to connect the diluent container and the pharmaceutical vial in fluid communication.

In another aspect, the system for administering a pharmaceutical solution can include an infusion set having a second connector configured to penetrate the second temporary closure of the pharmaceutical vial to connect the infusion set and the pharmaceutical vial in fluid communication.

In another aspect, the hollow elongated body of the vial can include a first body section that includes the first end and a second body section that includes the second end.

In another aspect, the first body section can include a first inner diameter and the second body section can include a second inner diameter less than the first inner diameter.

In another aspect, the hollow elongated body can include a third body section between the first body section and the second body section.

In another aspect, the third body section can include a tapered funnel between the first passage and the second passage.

In another aspect, a method for reconstituting and administering an active pharmaceutical ingredient stored in a vial can include the steps of inserting a spike connected to a diluent container containing a diluent through a first temporary closure of the vial to connect the diluent container in fluid communication with the vial, transferring the diluent from the diluent container and into the vial, reconstituting the active pharmaceutical ingredient with the diluent to form a solution, inserting a fluid drawing member connected to a fluid delivery device through a second temporary closure of the vial to connect the fluid delivery device in fluid communication with the vial, and administering the solution through the fluid drawing member and the fluid delivery device into a patient.

### BRIEF DESCRIPTION OF THE DRAWINGS

The drawing figures depict one or more implementations by way of example only, not by way of limitations. In the figures, like reference numerals can refer to the same or similar elements.

FIG. 1 is a perspective view of a container assembly according to a first embodiment featuring a VSP and bag in a disconnected state.

FIG. 2 is a front elevation view of the container assembly of FIG. 1 showing the VSP and bag in a connected state.

FIG. 3 is a front cross section view of the container assembly of FIG. 1 in the connected state.

FIG. 4 is a perspective view of a VSP of the container assembly of FIG. 1.

FIG. 5 is a front elevation view of the VSP of the container assembly of FIG. 1.

FIG. 6 is a front cross section view of the VSP of the container assembly of FIG. 1.

FIG. 7 is a perspective view of a VSP according to another embodiment.

FIG. 8 is a front elevation view of the VSP of FIG. 7.

FIG. 9 is a front cross section view of the VSP of FIG. 7.

FIG. 10 is a front elevation view of a VSP according to another embodiment.

FIG. 11 is a front cross section view of the VSP of FIG. 10.

FIG. 12 is a perspective view of the VSP of FIG. 10.

FIG. 13 is an exploded perspective view of the VSP of FIG. 10.

FIG. 14 is a front elevation view of a VSP according to another embodiment.

FIG. 15 is a front cross section view of the VSP of FIG. 14.

FIG. 16 is a perspective view of the VSP of FIG. 14.

FIG. 17 is an exploded perspective view of the VSP of FIG. 14.

FIG. 18 is a front elevation view of a VSP according to another embodiment.

FIG. 19 is a front cross section view of the VSP of FIG. 18.

FIG. 20 is a perspective view of the VSP of FIG. 18.

FIG. 21 is an exploded perspective view of the VSP of FIG. 18.

FIG. 22 is a front elevation view of a VSP according to another embodiment.

FIG. 23 is a front cross section view of the VSP of FIG. 22.

FIG. 24 is a perspective view of the VSP of FIG. 22.

FIG. 25 is an exploded perspective view of the VSP of FIG. 22.

FIG. 26 is a front elevation view of a VSP according to another embodiment.

FIG. 27 is a front cross section view of the VSP of FIG. 26.

FIG. 28 is a perspective view of the VSP of FIG. 26.

FIG. 29 is an exploded perspective view of the VSP of FIG. 26.

FIG. 30 is a schematic view of a system for administering a pharmaceutical solution according to the present disclosure, with portions truncated and/or shown in cross section.

FIG. 31 is a block diagram of a method for reconstituting and administering an active pharmaceutical ingredient according to the present disclosure.

### DETAILED DESCRIPTION

In the following detailed description, numerous specific details are set forth by way of examples in order to provide a thorough understanding of the relevant teachings. It will be understood that such examples are non-limiting. Numerous variations, changes and substitutions will occur to those skilled in the art without departing from the scope of the present disclosure and its teachings.

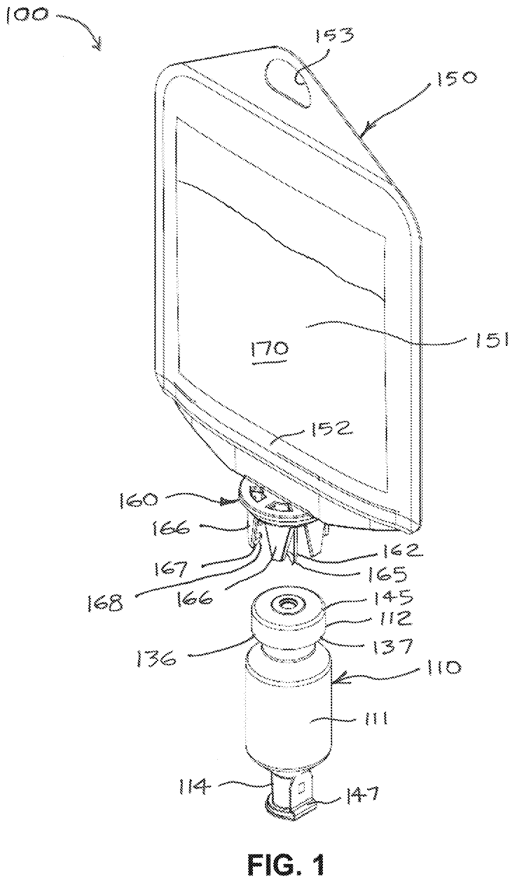

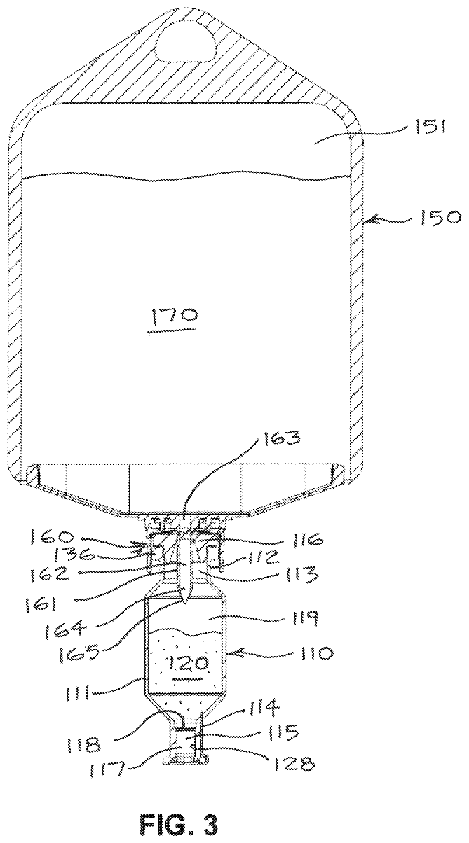

Referring to FIGS. 1-3, a container assembly 100 for reconstituting an active pharmaceutical ingredient is shown according to one embodiment, with components shown in a disassembled state. Container assembly 100 includes a VSP 110 and a flexible container or bag 150. VSP 110 contains an API 120 in dry or concentrated liquid form. Bag 150 has a compartment 151 that contains a diluent 170. Examples of diluents include, but are not limited to, normal saline, sterile water, and a solution of dextrose and water.

VSP 110 is configured to attach directly to bag 150 in fluid communication. Bag 150 has a weld 152 that seals compartment 151 and prevents diluent 170 from exiting the bag after VSP 110 is attached. Once VSP 110 and bag 150 are attached, the connected components can be stored with the API 120 and diluent 170 separated from one another in their respective containers. API 120 can be reconstituted by opening weld 152 and shaking container assembly 100 to dissolve the API into diluent 170.

VSP 110 has a hollow elongated body 111 with a first end 112 and a second end 114. First end 112 defines a first passage 113, and second end 114 defines a second passage 115. First passage 113 is sealed by a first temporary closure 116, and second passage 115 is sealed by a second temporary closure 118. The term “temporary closure”, as used herein, means a structure that seals an opening or passage in a first state and unseals an opening or passage in a second state. The temporary closure changes from the first state to the second state in response to mechanical force that is introduced during fluid connection to another vessel or body. Temporary closures according to the present disclosure enclose and protect the API during distribution and storage of the VSP, but allow access to the API at appropriate times for reconstitution and administration of the drug in solution. Non-limiting examples of temporary closures that can be used on either end of the VSP include, but are not limited to, septums, stoppers, frangible members, and valves. Other non-limiting examples of temporary closures that can be used on either end of the VSP include a port valve similar or identical to what is described in U.S. Pat. No. 6,871,838, an injection set adapter element similar or identical to what is described in U.S. Pat. No. 9,532,927, a binary connection geometry similar or identical to what is described in U.S. Pat. No. 11,311,458, and a connection site similar or identical to what is described in U.S. Pat. No. 5,199,948. Thus, the contents of U.S. Pat. Nos. 6,871,838, 9,532,927, 11,311,458 and 5,199,948 are incorporated by reference herein in their entireties and for all purposes.

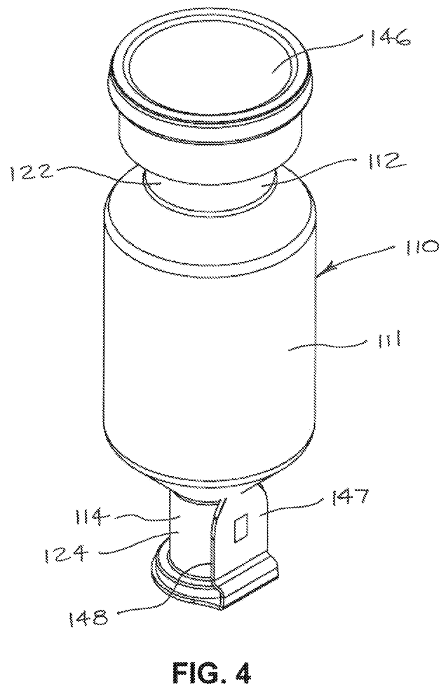

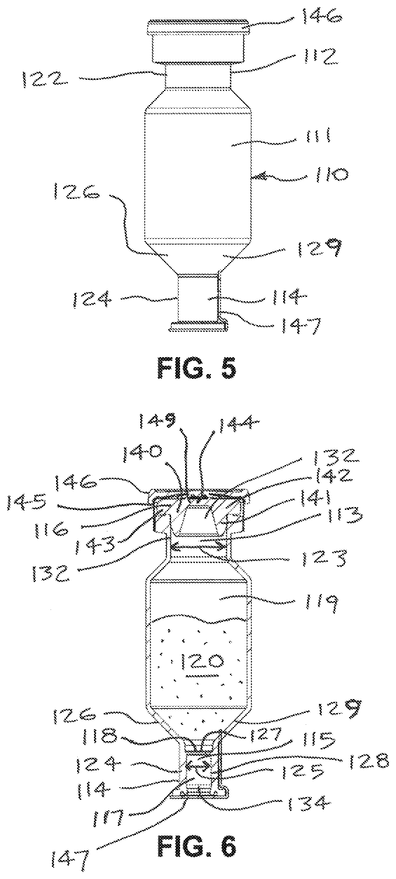

FIGS. 4-6 show the VSP 110 in more detail. A chamber 119 is formed inside hollow elongated body 111 between first passage 113 and second passage 115. A portion of chamber 119 is filled with API 120. Hollow elongated body 111 comprises a first body section 122 that includes first end 112 and a second body section 124 that includes second end 114. First body section 122 has a first inner diameter 123, and second body section 124 has a second inner diameter 125 less than the first inner diameter. Hollow elongated body 111 also includes a third body section 126 between first body section 122 and second body section 124. Third body section 126 forms a tapered funnel 129 between first passage 113 and second passage 115.

First end 112 defines a first opening 132, and second end 114 defines a second opening 134. First temporary closure 116 is positioned in first opening 132, and second temporary closure 118 is positioned in second passage 115 in a location that is recessed from second opening 134. Second passage 115 forms a receptacle 117 configured to receive a spike on an infusion set.

First temporary closure 116 is a stopper 140 formed of an elastomeric material. Second temporary closure 118 is a breakable membrane or web 127 formed by injection molding. Web 127 is configured to separate from an inner wall 128 surrounding second passage 115 when a spike on an infusion set is inserted in receptacle 117 and advanced. As noted previously, the first and second temporary closures can be provided in a variety of different forms, and need not have the same designs shown. For example, first temporary closure could be a breakable member, and/or the second temporary closure could be a stopper.

Stoppers according to the present disclosure can be penetrated by a cannula, spike, or other hollow piercing element on a diluent container to connect the interior of the diluent container in fluid communication with the chamber inside the VSP. Examples of stopper materials that can be used include, but are not limited to, silicone, bromobutyl rubber, chlorobutyl rubber, and polyisoprene. In the present example, stopper 140 is made of bromobutyl rubber, which is configured to be penetrated by a spike adaptor or “vial spike” 160 on bag 150.

Referring back to FIGS. 1-3, vial spike 160 includes a spike body 161 that forms a cannula with a lumen 162. Lumen 162 has a first end 163 and a second end 164. First end 163 is positioned in proximity to compartment 151 in bag 150. Spike body 162 further includes a sharp tip 165 that surrounds second end 164 of lumen 162. Sharp tip 165 is configured to puncture and penetrate through stopper 140.

Referring again to FIG. 6, stopper 140 includes a first section 141 configured to be inserted in first opening 132 and seal first passage 113. Stopper 140 also includes a second section 142 having an outer rim 143 and a center section 144. Center section 144 forms a thin membrane 149 that is configured to be penetrated by sharp tip 165 of spike body 162. In this arrangement, spike body 162 can be advanced through center section 144 of stopper 140 to fluidly connect lumen 162 to chamber 119.

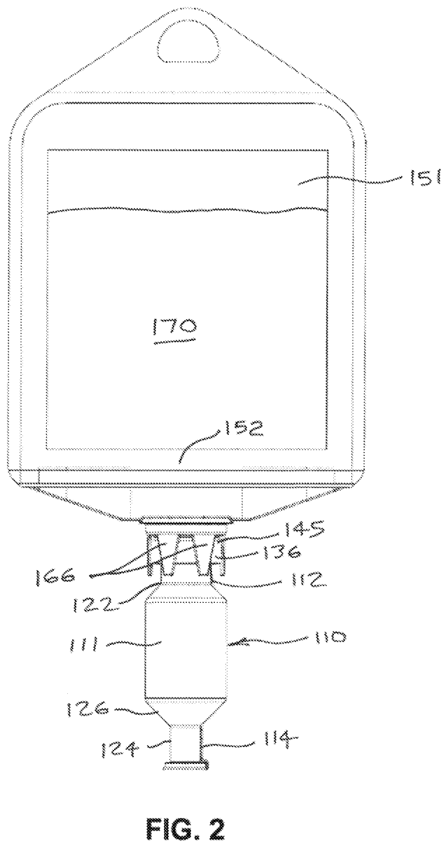

Referring back to FIGS. 1 and 2, vial spike 160 also includes a radial array of snap tabs 166 that are arranged around spike body 162. Snap tabs 166 are designed to align spike body 162 with center section 144 of stopper 140 during connection of vial spike 160 with VSP 110. This alignment is accomplished by cooperating mechanisms on VSP 110 and vial spike 160. First end 112 of VSP 110 has a first flange 136 that extends radially outwardly from hollow elongated body 111. First end 112 is also covered by an aluminum cap 145 that secures stopper 140 in first passage 113. First flange 136 and cap 145 are configured to engage with snap tabs 166 to connect VSP 110 with bag 150. Each snap tab 166 has a barbed end 167 that extends radially inwardly toward spike body 162. Each barbed end 167 has a leading edge or ramp 168. Cap 145 has an outer diameter 137 that is larger than a clearance space between barbed ends 167. Therefore, cap 145 is configured to abut ramps 168 on snap tabs 166, at which point the abutting surfaces encounter resistances that center first end 112 of VSP 110 relative to vial spike 160.

VSPs according to the present disclosure can have one or more components that protect the first and second ends from contamination and/or secure the stopper in the first end. In the present example, cap 145 is crimped over stopper 140. First end 112 also includes a plastic cover 146 detachably connected over cap 145, as shown in FIG. 4. Second end 114 is covered by a removable barrier 147 applied over the second end. Removable barrier 147 has an adhesive 148 that adheres to second end 114, allowing the removable barrier to be peeled off of the second end at an appropriate time, such as just prior to when the second end is connected to an infusion set.

VSPs according to the present disclosure can be manufactured with geometries that work with aseptic filling machinery that fills standard vials with API. In addition, VSPs according to the present disclosure can be manufactured with geometries that cooperate with conventional or commercially available vial adaptors and infusion sets. In the present example, first flange 136 has an outer diameter of 19.9 mm, and receptacle 117 has an inner diameter of between about 4.2 mm and about 21.0 mm.

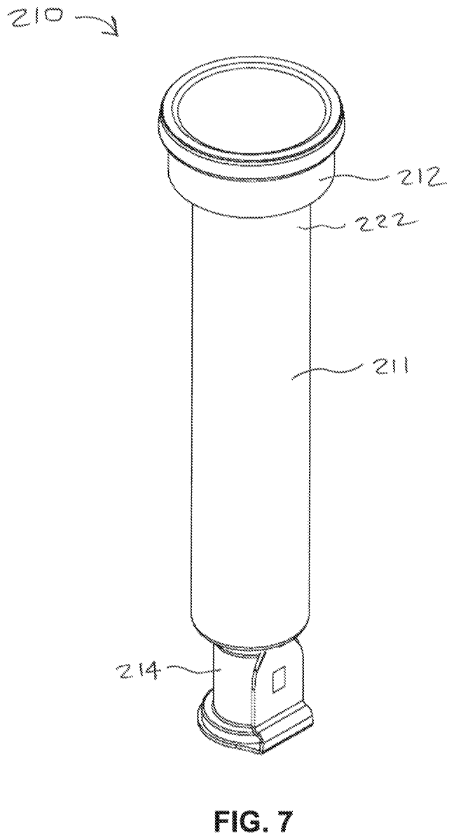

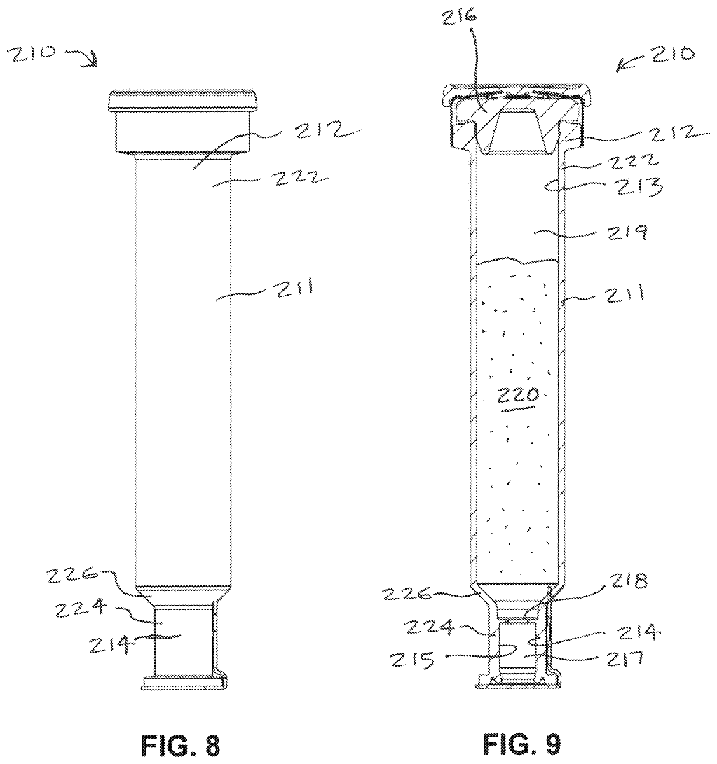

FIGS. 7-9 show a VSP 210 according to another example. VSP 210 has many of the same features as VSP 110, including but not limited to a hollow elongated body 211, a first end 212, a second end 214, a first passage 213, a second passage 215, a first body section 222, a second body section 224, a third body section 226, a chamber 219 containing an API 220, a first temporary closure 216, a second temporary closure 218, and a receptacle 217. The internal volumes of VSP 110 and VSP 210 are the same. Moreover, first end 212 has the same outer geometry as first end 112, and second end 222 has the same outer geometry as second end 122. Therefore, VSP 210 is configured to connect to a diluent container and infusion set in the same manner as VSP 110. For brevity, many of the features of VSP 210 that correspond to features on VSP 110 will not be described in detail, with the understanding that the corresponding descriptions provided for VSP 110 apply equally to VSP 210 and need not be repeated.

VSP 210 differs from VSP 110 with respect to the dimensions of hollow elongated body 211. The axial length of hollow elongated body 211 is longer than the axial length of hollow elongated body 111. In addition, first body section 222 has a uniform diameter along its axial length, while first body section 122 has a diameter that increases as it extends toward third body section 126. Third body section 226 has a diameter that is greater than the diameter of third body section 126. VSP 210 also differs from VSP 110 in how it is manufactured. In particular, VSP 210 is manufactured with a single-step injection molding process. VSP 110 is manufactured from two separate pieces.

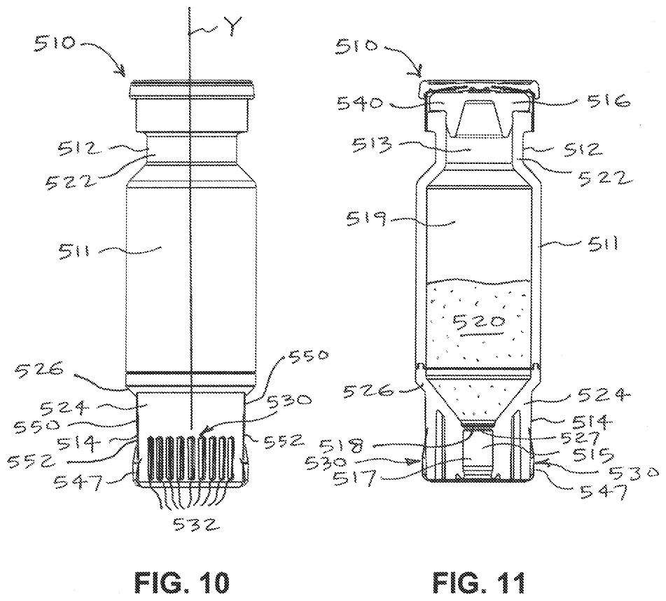

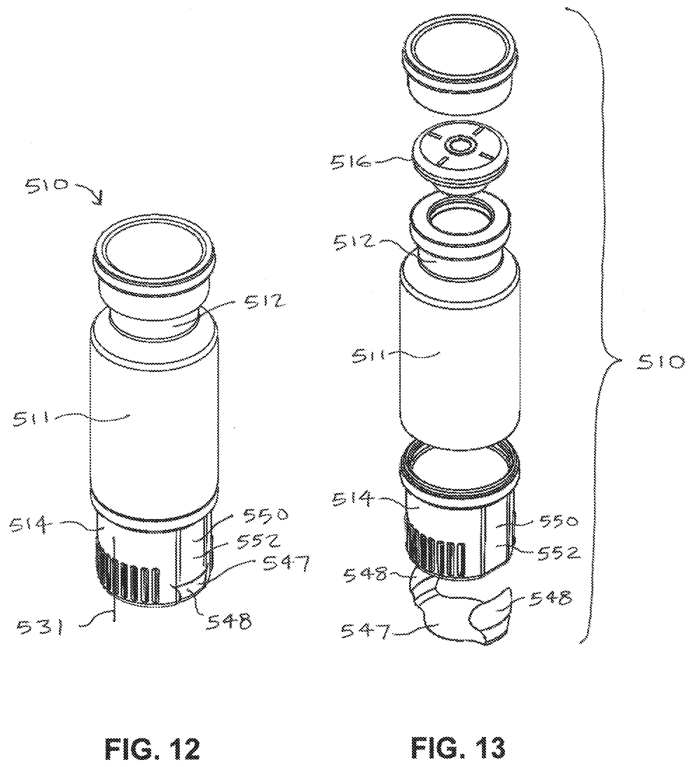

FIGS. 10-13 show a VSP 510 according to another example. VSP 510 has many of the same features as VSP 110, including but not limited to a hollow elongated body 511, a first end 512, a second end 514, a first passage 513, a second passage 515, a first body section 522, a second body section 524, a third body section 526, a chamber 519 containing an API 520, a first temporary closure 516, a second temporary closure 518, a receptacle 517, and a removable barrier 547 that covers the second end. First temporary closure 516 is a stopper 540, and second temporary closure 518 is a breakable membrane or web 527. VSP 510 is configured to connect to a diluent container and infusion set in the same manner as the prior embodiments. For brevity, many of the features of VSP 510 that correspond to features on VSP 110 will not be described in detail, with the understanding that the corresponding descriptions provided for VSP 110 apply equally to VSP 510 and need not be repeated.

The geometry of VSP 510 allows it to be handled, slid, and conveyed down vial filling machinery such as chutes, buffering areas, and transfer between machinery stations, like a standard vial. The wider base of VSP 510, when compared to other designs such as VSP 110 or VSP 210, makes VSP 510 more stable and less prone to tipping over than other geometries.

VSP 510 differs from the previous embodiments in that it features a base that is wider, making the VSP stable when placed on a counter or being conveyed on a chute. The lower geometry can be formed using molding techniques that reduce the likelihood of plastic sinks. In the present example, a series 530 of slots or holes 532 is formed on diametrically opposed sections of the second body portion 524. Holes 532 reduce the amount of exterior material while still preserving the inner geometry that is more important to the receptacle 517.

VSP 510 also differs from previous embodiments in that it features two diametrically opposed flat surfaces 550 on second body portion 524. Each flat surface 550 is angularly offset from a center line 531 (FIG. 12) of each series 530 of holes 532 by an angle of 90 degrees with respect to the circumference of second body portion 524. Each flat surface 550 forms a smooth planar face 552. Removable barrier 547 has two opposing ends 548, each end being positioned to mate with one of the planar faces 552. Opposing ends 548 each have an adhesive side that can be pressed against one of the smooth planar faces 552 to affix removable barrier 547 to second body portion 524. Smooth planar faces 552 have no discontinuities and ensure that the entire adhesive surface of each opposing end 548 adheres to second body portion 524.

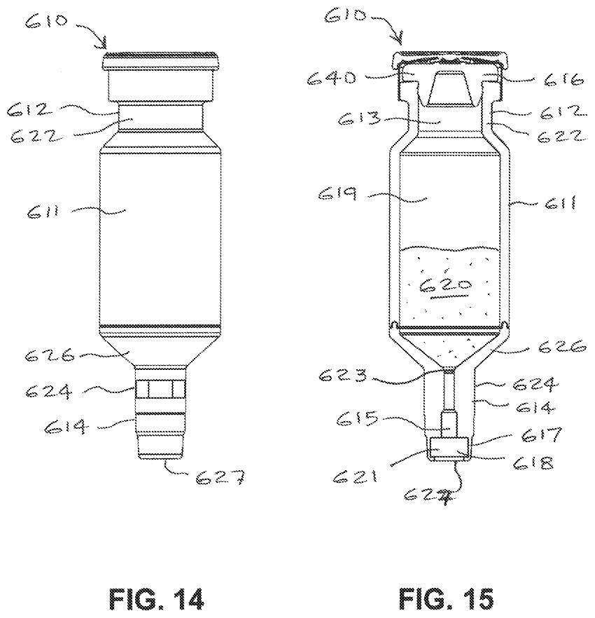

FIGS. 14-17 show a VSP 610 according to another example. VSP 610 has many of the same features as VSP 110, including but not limited to a hollow elongated body 611, a first end 612, a second end 614, a first passage 613, a second passage 615, a first body section 622, a second body section 624, a third body section 626, a chamber 619 containing an API 620, a first temporary closure 616, a second temporary closure 618 and a receptacle 617 for housing the second temporary closure. First temporary closure 616 is a stopper 640, and second temporary closure 618 is a septum 621 configured to form a dry break coupling 627 with a septum on another device. A “dry break coupling”, as used herein, means a coupling that prevents liquid or vapor from being released to the environment during coupling or decoupling of two components. For brevity, many of the features of VSP 610 that correspond to features on VSP 610 will not be described in detail, with the understanding that the corresponding descriptions provided for VSP 110 apply equally to VSP 610 and need not be repeated.

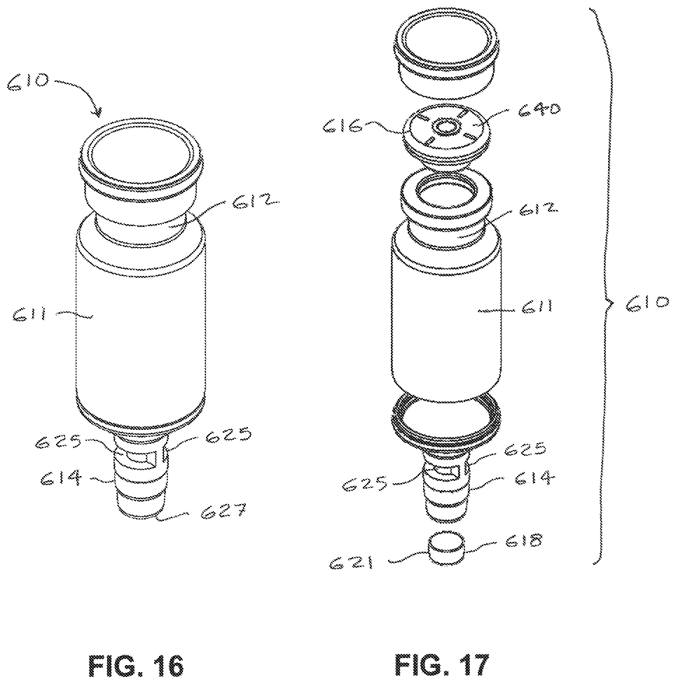

If desired, second temporary closure 618 can be separated from the API 620 with an optional third temporary closure to limit exposure of the API to only the material of the hollow elongated body 611, stopper 640, and third body section 626. In the present example, a third temporary closure 623 is schematically shown in FIG. 15 between API 620 and second temporary closure 618. Third temporary closure 623 can take the form of other temporary closures described in this disclosure, including but not limited to septums, stoppers, frangible members, and valves. VSP 610 can also incorporate other features described in this disclosure, including but not limited to a wider base to facilitate better physical stability of the product for storage and conveyance. In addition, second body section 624 can be formed with geometry to aid in the attachment of another device. FIGS. 16 and 17 show second body section 624 with a pair of cutouts 625 to allow certain devices to be attached to VSP 610.

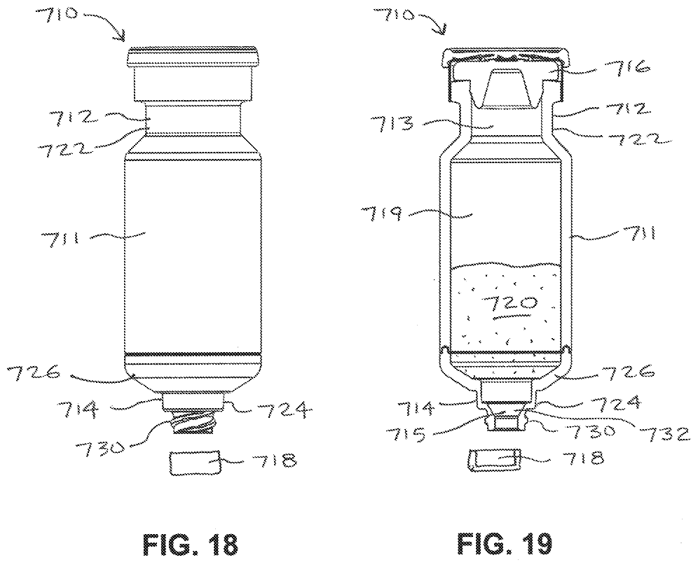

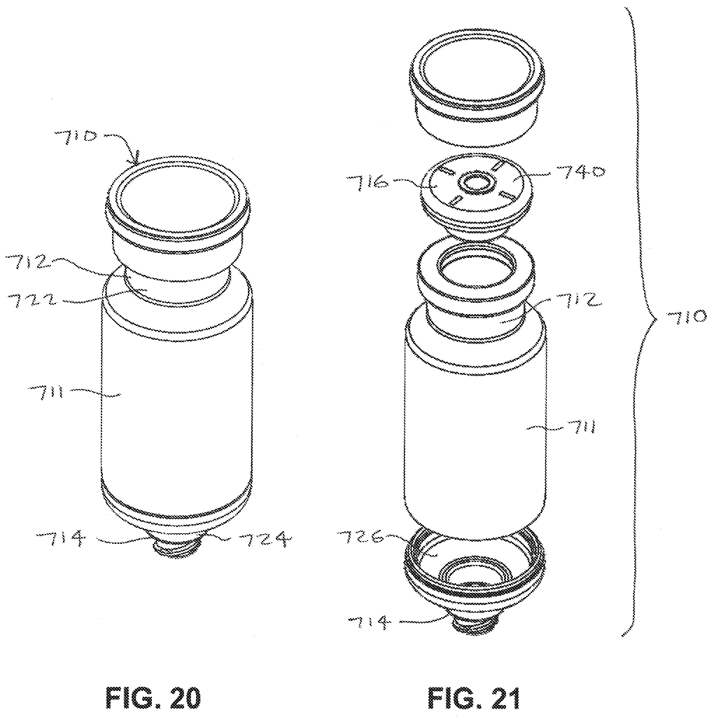

FIGS. 18-21 show a VSP 710 according to another example. VSP 710 has many of the same features as VSP 110, including but not limited to a hollow elongated body 711, a first end 712, a second end 714, a first passage 713, a second passage 715, a first body section 722, a second body section 724, a third body section 726, a chamber 719 containing an API 720, a first temporary closure 716, a receptacle 717, and a second temporary closure 718 shown schematically. For brevity, many of the features of VSP 710 that correspond to features on VSP 110 will not be described in detail, with the understanding that the corresponding descriptions provided for VSP 110 apply equally to VSP 710 and need not be repeated.

First temporary closure 716 is a stopper 740. Second temporary closure 718 can be any appropriate closure mechanism, such as a Luer cap or removable barrier. Second end 714 includes a Luer connector featuring an external thread 730 and a valve 732 inside second passage 715. A male Luer would connect to second end 714 to enable fluid communication with chamber 719. VSP 710 can also incorporate other features described in this disclosure, including but not limited to a wider base to facilitate better physical stability of the product for storage and conveyance.

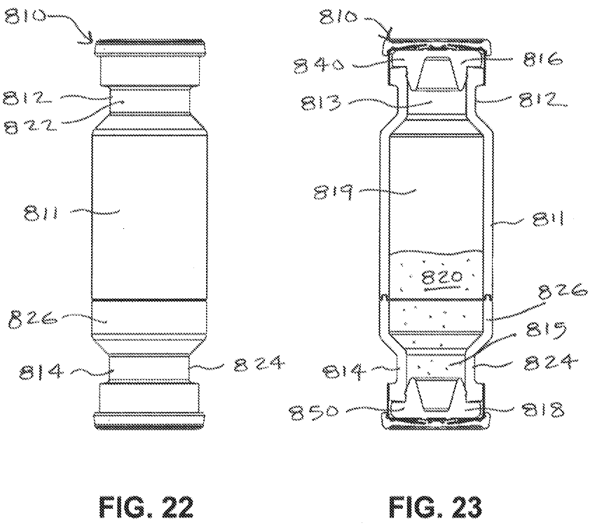

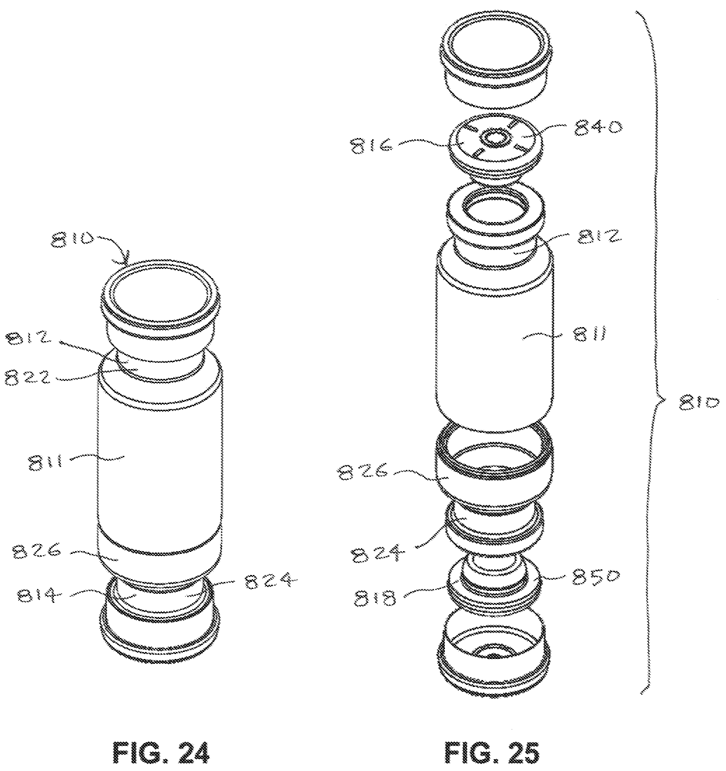

FIGS. 22-25 show a VSP 810 according to another example. VSP 810 has many of the same features as VSP 110, including but not limited to a hollow elongated body 811, a first end 812, a second end 814, a first passage 813, a second passage 815, a first body section 822, a second body section 824, a third body section 826, a chamber 819 containing an API 820, a first temporary closure 816, and a second temporary closure 818. First temporary closure 816 is a first stopper 840, and second temporary closure 818 is a second stopper 850. First end 812, first passage 813 and first stopper 840 have dimensions and geometries that are identical to those of second end 814, second passage 815 and second stopper 850, respectively. As such, hollow elongated body 811 is symmetrical with respect three different axes. For brevity, many of the features of VSP 810 that correspond to features on VSP 110 will not be described in detail, with the understanding that the corresponding descriptions provided for VSP 110 apply equally to VSP 810 and need not be repeated. Since the first end and second end geometries are substantially the same, having the API 820 exposed to first stopper 840 and second stopper 850 can simplify the manufacturing.

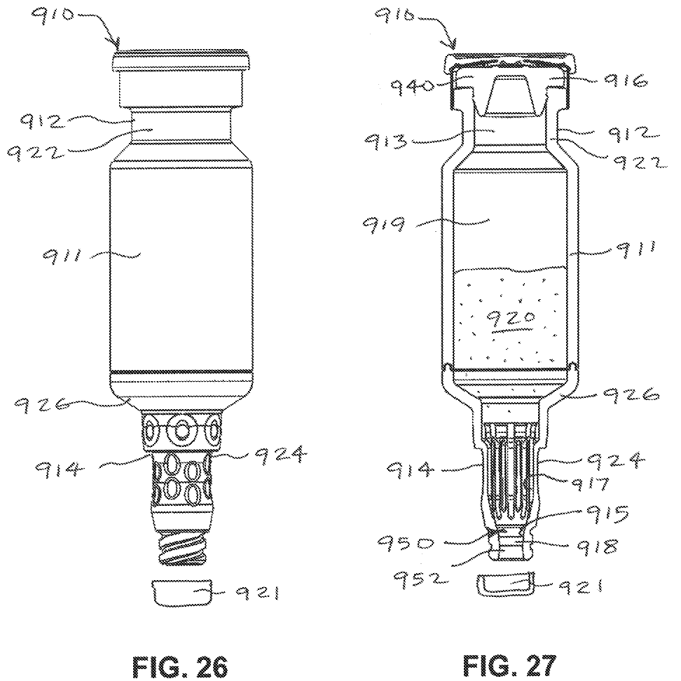

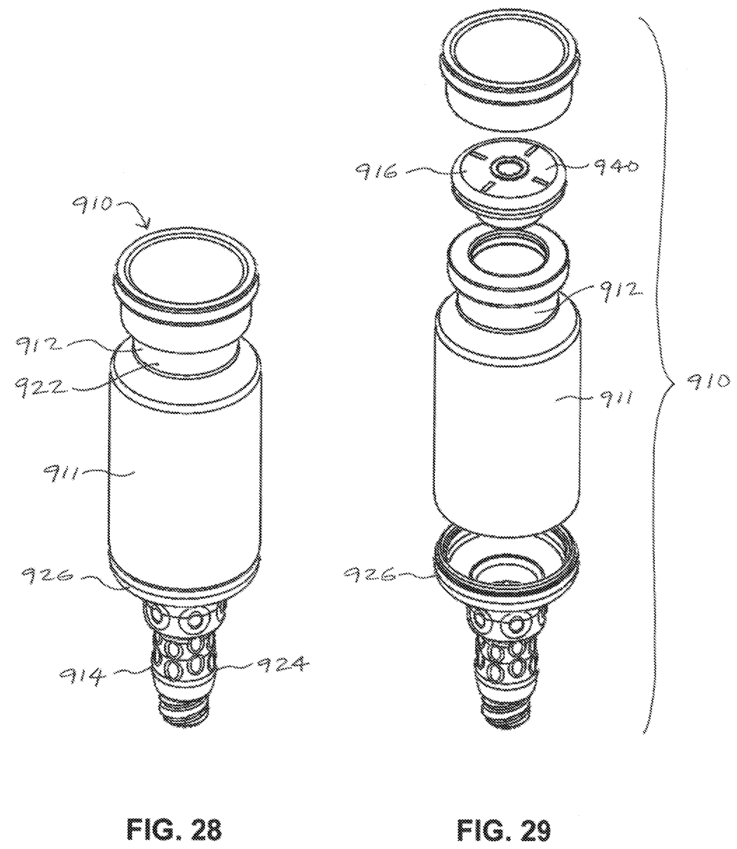

FIGS. 26-29 show a VSP 910 according to another example. VSP 910 has many of the same features as VSP 110, including but not limited to a hollow elongated body 911, a first end 912, a second end 914, a first passage 913, a second passage 915, a first body section 922, a second body section 924, a third body section 926, a chamber 919 containing an API 920, a first temporary closure 916, and a second temporary closure 918 shown schematically. First temporary closure 916 is a stopper 940, and second temporary closure 918 is a displacement valve 950 featuring a hollow piston 952 formed of resilient flexible material, such as silicon rubber.

Second end 914 forms a chamber 917 that houses piston 952. Piston 952 is elastically deformable in chamber 917 between a sealing state and an open state. In the sealing state, shown in FIG. 27, piston 952 is in a relaxed state in which the piston maintains its original shape without deformation. In this state, piston 952 is received in second passage 915 and fluidly seals second end 914. In the open state, piston 952 is axially deformed and collapsed into chamber 917. This collapse may be caused by a male Luer portion of a needleless syringe or other fluid source being inserted into second end 914. The male Luer portion or other fluid source axially compresses piston 952 to move it out of the second end 914. This mechanical collapse causes a slit in piston 952 to open, creating a fluid path into second passage 915. VSPs according to this embodiment can incorporate a variety of collapsible pistons, including but not limited to pistons shown and described in U.S. application Ser. No. 17/689,428 and U.S. Pat. No. 6,871,838, the contents of both documents being incorporated by reference herein in their entireties. VSPs according to this embodiment can also incorporate a variety of collapsible pistons on the market, including but not limited to pistons used in positive-displacement needleless connectors marketed by B. Braun Medical, Inc. under the federally registered trademark CARESITE®. Moreover, VSPs according to this embodiment can feature additional temporary closures. FIGS. 26 and 27 schematically show an optional closure 921 that can be placed over second end 914. Closure 921 can be a Lure cap or removable barrier, for example.

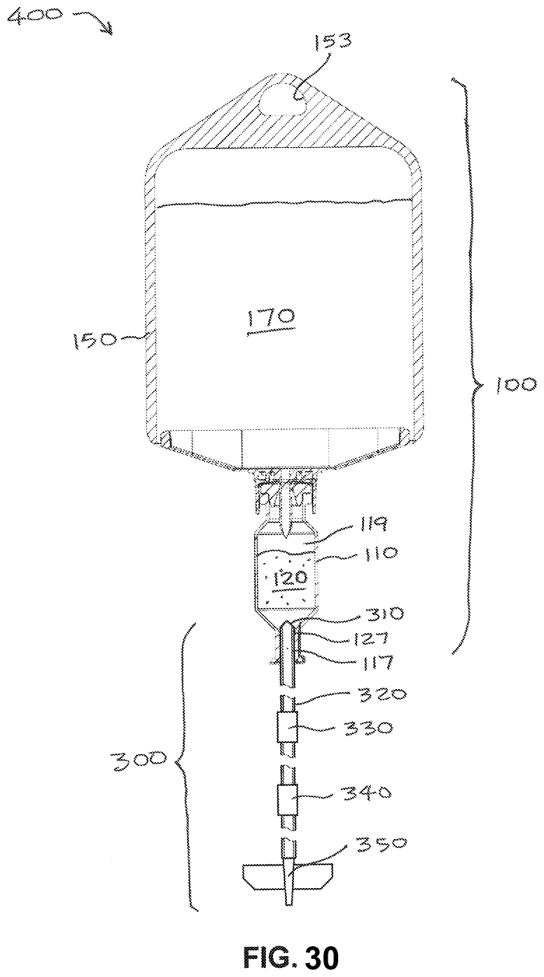

FIG. 30 shows a system 400 for administering a pharmaceutical solution, which includes container assembly 100 attached to an infusion set 300. Container assembly 100 is shown with VSP 110 and bag 150. VSP 110 contains API 120 and bag 150 contains diluent 170. It will be appreciated, however, that system 400 can feature a different VSP, including but not limited to any other VSP embodiment described herein. Bag 150 has an opening 153 at an end opposite vial spike 160. Opening 153 allows bag 150 and VSP 110 to be hung on an IV bag hanger or hook that is elevated above the catheter to administer the reconstituted drug to a patient by gravity.

Infusion set 300 includes an infusion set spike 310 connected to tubing 320. Infusion set spike 310 is shown inserted into receptacle 117 and penetrated through web 127 to connect tubing 320 in fluid communication with chamber 119. Infusion sets according to the present disclosure can also include different accessories to control the administration of the reconstituted drug. In the present example, infusion set 300 includes a drip chamber 330 that allows gas to rise out of the solution and prevent the gas from being passed downstream into the patient. Infusion set 300 also includes a roller clamp 340 that a user can manipulate to control the flow of solution, and a catheter 350 that is placed in the patient.

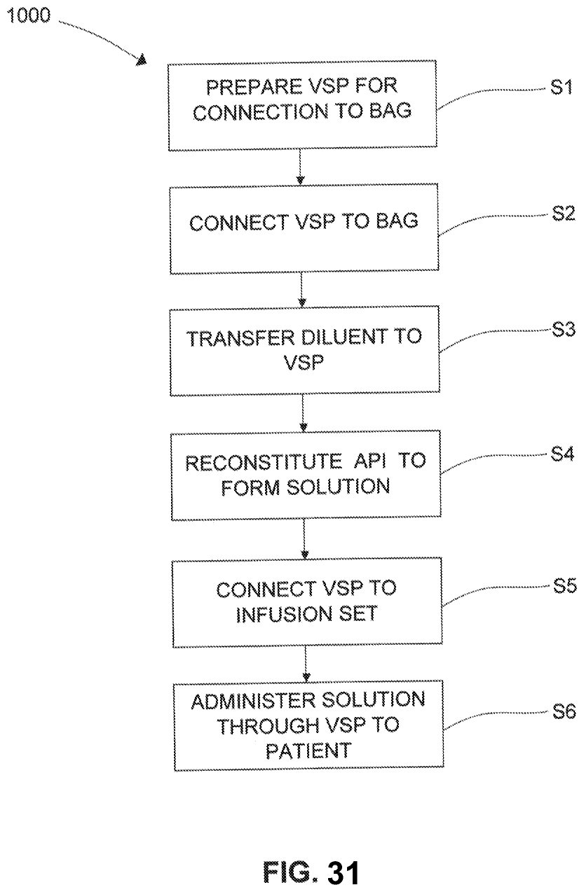

FIG. 31 is a block flow diagram of a method 1000 for reconstituting and administering an active pharmaceutical ingredient. The steps of method 1000 can be practiced using the previously described system 400 or other system that features a VSP according to the present disclosure. For purposes of this description, method 1000 will be described with reference to VSP 110, bag 150 and infusion set 300.

In step S1, VSP 110 is prepared for connection to bag 150. For example, VSP 110 and bag 150 can each be removed from storage and transported to a location for administration to a patient. In addition, protective covers and packaging can be removed from VSP 110 and bag 150. For example, plastic cover 146 can be removed from first end 112 of VSP 110 to expose cap 145.

In step S2, VSP 110 is connected to bag 150. First end 112 of VSP 110 is inserted between barbed ends 167 of snap tabs 166 and advanced in an axial direction relative to vial spike 160. First end 112 is advanced until sharp tip 165 of spike body 162 contacts a center portion of cap 145. The user then firmly presses vial spike 160 downwardly onto VSP 110 so that spike body 162 penetrates through cap 145 and center section 144 of stopper 140. At this point, stopper 140 is unsealed, and the interior of spike body is in fluid communication with first passage 113. Diluent 170 is prevented from entering VSP 110 because weld 152 in bag 150 is not yet broken.

As first end 112 advances toward vial spike 160, cap 145 abuts ramps 168, which displaces snap tabs 166 radially outwardly under stored energy. Vial spike 160 continues to be pressed firmly until first flange 136 and cap 145 clear ramps 168, at which time barbed ends 167 are no longer flexed outwardly. At such time, snap tabs 166 release their stored energy and snap radially inwardly toward VSP 110, with barbed ends 167 in engagement with first flange 136 and cap 145 in an interlocking fit. This interlocking fit prevents VSP 110 from being pulled off of vial spike 160.

In step S3, diluent 170 is transferred from bag 150 into VSP 110. Weld 152 in bag 150 is broken to allow diluent 170 to enter spike body 162. Diluent 170 travels through spike body 162 and first passage 113 of VSP into chamber 119 where it can mix with API 120. At this stage, first end 112 of VSP 110 is unsealed by spike body 162, but second end 114 remains sealed by web 127. Therefore, API 120 and diluent 170 are confined within container assembly 100.

In step S4, API 120 is reconstituted with diluent 170 by mechanical agitation of container assembly 100. For example, the user can shake bag 150 and VSP 110 in a back and forth or up and down motion to displace API 120 and diluent 170 back and forth in container assembly 100 until the API is dissolved into solution. The user can observe the mixture through the wall of bag 150 to visually confirm when API 120 is completely dissolved.

In step S5, VSP 110 is connected to infusion set 300. Barrier 147, if present, can be peeled away from second end 114 of VSP to expose receptacle 117. Infusion set spike 130 is then inserted into receptacle 117 and advanced until the infusion set spike penetrates through web 127. Once web 127 is penetrated, chamber 119 is connected in fluid communication with infusion set spike 130 and tubing 132.

In step S6, the reconstituted drug solution is administered to the patient through VSP 110. For example, bag 150 can be hung on an IV bag hanger or hook using opening 153 to elevate the bag and VSP 110 above the patient. Solution can then be administered through VSP 110 and infusion set 300 by gravity.

Although the aforementioned steps are shown and described in a specific sequence, it will be appreciated that methods according to the present disclosure need not be performed in the same sequence. For example, the VSP can be connected to the infusion set prior to connecting VSP to the diluent container. In such a case, the VSP can be designed to connect to an infusion set spike in a non-activated state in which the infusion set spike does not penetrate the second temporary closure at the second end of the VSP. After connecting the diluent container to the VSP and reconstituting the API, the infusion set spike can be advanced into the VSP, or otherwise manipulated, to unseal the second temporary closure in the VSP and allow the solution to enter the infusion set.

Methods according to the present disclosure can also include one or more additional steps that occur before or after any of the steps shown. For example, a method can include one or more steps that occur after the VSP is connected to the infusion set. These additional steps might include, but are not limited to, observing the rate of flow through the line and adjusting the flow rate.

Multi-functional VSPs and methods of the present disclosure allow an API and diluent to be packaged in separate facilities. Therefore, facilities do not have to be set up to fill containers with both APIs and diluents in aseptic processes. In addition, the geometry at the first end of the VSPs allow the VSPs to comply with industry standards for vials, so that the VSPs can be filled with standard filling machinery. VSPs according to the present disclosure also allow APIs to be reconstituted with diluent and administered intravenously with as little as two fluid connections being established. Therefore, VSPs according to the present disclosure replace conventional vials with a more functional alternative that not only provides a storage vessel for API but also a conduit for IV administration. VSPs require no additional components or fluid connections when used in place of standard vials, and bags do not require a separate outlet for administering solution because the solution can be administered directly through the VSPs.

VSPs according to the present disclosure can include one or more mechanisms to prevent or mitigate against oxygen, light and/or moisture penetration. Such mechanisms can include but are not limited to overwraps, pouches, films (e.g. aluminum film), barriers, wraps, sheaths, oxygen scavengers, and/or desiccants.

What is claimed:

1. A pharmaceutical vial for packaging, storing, reconstituting and administering an active pharmaceutical ingredient, the pharmaceutical vial comprising:
a hollow elongated body;
a first end defining a first passage;
a second end defining a second passage;
a first temporary closure sealing the first passage; and
a second temporary closure sealing the second passage,
the hollow elongated body comprising a first body section that includes the first end and a second body section that includes the second end,
the first body section having a first inner diameter and the second body section having a second inner diameter less than or equal to the first inner diameter,
the hollow elongated body further comprising a third body section between the first body section and the second body section, and
the third body section comprising or forming a tapered funnel between the first passage and the second passage.

2. The pharmaceutical vial of claim 1, wherein the first end defines a first opening and the second end defines a second opening.

3. The pharmaceutical vial of claim 2, wherein the first temporary closure is positioned in the first opening.

4. The pharmaceutical vial of claim 2, wherein the second temporary closure is positioned in the second passage and recessed from the second opening.

5. The pharmaceutical vial of claim 4, wherein the second passage forms a receptacle configured to receive a spike on an infusion set.

6. The pharmaceutical vial of claim 5, wherein the second temporary closure comprises a breakable member configured to separate from an inner wall of the second passage when a spike on an infusion set is received in the second passage.

7. The pharmaceutical vial of claim 1, wherein the first temporary closure comprises an elastomeric material configured to be penetrated by a cannula or a spike.

8. The pharmaceutical vial of claim 7, wherein the first temporary closure comprises a stopper.

9. The pharmaceutical vial of claim 8, wherein the first end comprises a cap that is crimped over the stopper.

10. The pharmaceutical vial of claim 9, wherein the first end comprises a cover that is detachably connected to the first body section and over the cap.

11. The pharmaceutical vial of claim 1, wherein the first end comprises a first flange extending radially outwardly from the hollow elongated body.

12. The pharmaceutical vial of claim 1, wherein the second passage and second temporary closure are covered by a removable barrier applied over the second end.

13. The pharmaceutical vial of claim 1, further comprising the active pharmaceutical ingredient stored in the hollow elongated body.

14. The pharmaceutical vial of claim 1, wherein the second end is configured to form a dry break connection.

15. The pharmaceutical vial of claim 1, wherein the second end comprises a Luer connector.

16. The pharmaceutical vial of claim 1, wherein the second end comprises a stopper.

17. The pharmaceutical vial of claim 1, wherein the second end comprises a displacement valve.

18. The pharmaceutical vial of claim 1, further comprising one or more mechanisms for preventing or mitigating against oxygen, light and/or moisture penetration.

19. The pharmaceutical vial of claim 18, wherein the one or more mechanisms for preventing or mitigating against oxygen, light and/or moisture penetration comprises an overwrap, a pouch, a film, a barrier, a wrap, a sheath, an oxygen scavenger, and a desiccant.

20. A container assembly for reconstituting an active pharmaceutical ingredient with a diluent to form a solution, and for administering said solution to a patient, the container assembly comprising:
(A) a pharmaceutical vial configured to package, store and reconstitute the active pharmaceutical ingredient, and configured to administer the solution to the patient, the pharmaceutical vial comprising:
a hollow elongated body;
a first end defining a first passage;
a second end defining a second passage;
a first temporary closure sealing the first passage;
a second temporary closure sealing the second passage; and
(B) a diluent container configured to package and store the diluent, and configured to administer the solution, the diluent container comprising a connector configured to penetrate the first temporary closure of the pharmaceutical vial to connect the diluent container and the pharmaceutical vial in fluid communication for mixing the active pharmaceutical ingredient with the diluent,
the hollow elongated body comprising a first body section that includes the first end and a second body section that includes the second end,
the first body section having a first inner diameter and the second body section having a second inner diameter less than or equal to the first inner diameter,
the hollow elongated body further comprising a third body section between the first body section and the second body section, and
the third body section comprising or forming a tapered funnel between the first passage and the second passage.

21. A system for administering a solution comprised of an active pharmaceutical ingredient and a diluent to a patient, the system comprising:
a pharmaceutical vial configured to package, store and reconstitute the active pharmaceutical ingredient, and configured to administer the solution to the patient, the pharmaceutical vial comprising:
a hollow elongated body;
a first end defining a first passage;
a second end defining a second passage;
a first temporary closure sealing the first passage; and
a second temporary closure sealing the second passage;
a diluent container configured to package and store the diluent, and configured to administer the solution to the patient, the diluent container comprising a first connector configured to penetrate the first temporary closure of the pharmaceutical vial to connect the diluent container and the pharmaceutical vial in fluid communication; and
an infusion set comprising a second connector configured to penetrate the second temporary closure of the pharmaceutical vial to connect the infusion set and the pharmaceutical vial in fluid communication,
the hollow elongated body comprising a first body section that includes the first end and a second body section that includes the second end,
the first body section having a first inner diameter and the second body section having a second inner diameter less than the first inner diameter,
the hollow elongated body further comprising a third body section between the first body section and the second body section, and
the third body section comprising a tapered funnel between the first passage and the second passage.

22. A method for reconstituting and administering an active pharmaceutical ingredient stored in a vial, the vial having a first end defining a first passage, a second end defining a second passage, a first temporary closure sealing the first passage, and a second temporary closure sealing the second passage, the method comprising the steps of:
inserting a spike connected to a diluent container containing a diluent through the first temporary closure to connect the diluent container in fluid communication with the vial;
transferring the diluent from the diluent container and into the vial;
reconstituting the active pharmaceutical ingredient with the diluent to form a solution;
inserting a fluid drawing member connected to a fluid delivery device through the second temporary closure to connect the fluid delivery device in fluid communication with the vial; and
administering the solution through the fluid drawing member and the fluid delivery device into a patient.
